(19) United States
(12) Patent Application Publication
(10) Pub. No.: US 2017/0303537 A1
(43) Pub. Date: Oct. 26, 2017

(54) COMPOSITIONS OF A QUATERNARY AMMONIUM COMPOUND WITH A MONOCARBOXYLIC FATTY ACID

(71) Applicant: OMS INVESTMENTS, INC., Los Angeles, CA (US)

(72) Inventors: James Liang-Hiong CHIA, Columbus, OH (US); Laurence G. DAMMANN, Hilliard, OH (US); Doug HURAK, Columbus, OH (US); John KOENIG, Marysville, OH (US); Mike FAUST, Salem, OR (US)

(21) Appl. No.: 15/494,160

(22) Filed: Apr. 21, 2017

Related U.S. Application Data
(60) Provisional application No. 62/325,550, filed on Apr. 21, 2016.

(51) Int. Cl. A01N 33/12; A01N 37/02

(52) U.S. Cl. CPC A01N 33/12; A01N 37/02

(57) ABSTRACT

Compositions including a quaternary ammonium compound (such as alkyl dimethyl benzyl ammonium chloride) and a linear monocarboxylic fatty acid are disclosed. The compositions are useful to inhibit the growth of an organism or to remove or reduce a stain resulting from the growth of an organism. Such compositions are useful as a biocidal agent or cleaning agent against algae, lichen, moss, mold, or mildew.

### REFERENCE TO RELATED APPLICATIONS

The present application claims the priority of U.S. provisional application Ser. No. 62/325,550, entitled COMPOSITIONS OF A QUATERNARY AMMONIUM COMPOUND WITH A MONOCARBOXYLIC FATTY ACID, filed Apr. 21, 2016, and hereby incorporates the same application herein by reference in its entirety.

### TECHNICAL FIELD

The present disclosure generally relates to pesticidal stain removal compositions.

### BACKGROUND

Alkyl dimethyl benzyl ammonium chloride has been used as a pesticide against mold, mildew, algae, moss, and lichen. Products containing alkyl dimethyl benzyl ammonium chloride can be applied on outdoor surfaces such as exterior home surfaces, lawn and garden furniture, and boats and marina equipment to eliminate mold, mildew, moss, lichen, and algae.

### SUMMARY

According to one embodiment, a composition includes a quaternary ammonium compound and a linear monocarboxylic fatty acid. The quaternary ammonium compound comprises an alkyl chain.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts a photograph of a test surface 6.5 hours being treated with experimental formulations of an exemplary composition.

FIG. 2 depicts a photograph of the test surface after 24 hours.

FIG. 3 depicts a photograph of the test surface after four days.

### DETAILED DESCRIPTION

Compositions described herein can include a quaternary ammonium compound and a monocarboxylic fatty acid and/or plant essential oil are disclosed. These compositions can be useful for a variety of applications, including as a pesticide (e.g., herbicide, bactericide, fungicide, and/or algaecide) or as a cleaner for treating stains (e.g., by reducing, removing, and/or eliminating stains). The compositions can exist in any suitable physical form, including as a liquid, gel, or solid.

In certain embodiments, a composition can be effective to inhibit the growth of surface-growing organisms. As used herein, the term “surface-growing organisms” means organisms that can grow on hard surfaces of man-made structures. Examples of surface-growing organisms can include algae, lichen, fungi such as mold and mildew, and bryophytes such as mosses and liverworts. Examples of hard surfaces of man-made structures can include sidewalks, walkways, pavements, driveways, tiles, roads, roofs, exterior walls, interior walls, outdoor decks, gutters, siding, lawn furniture, bathrooms, and swimming pools. Such hard surfaces can be made of any of a variety of materials including concrete, brick, cement, asphalt, plastics, metals, ceramics, glass, wood, and combinations thereof.

Various quaternary ammonium compounds can be suitable for use in the compositions disclosed herein. For example, suitable quaternary ammonium compounds can have an alkyl chain. One example of a suitable quaternary ammonium compound is alkyl dimethyl benzyl ammonium chloride (“ADBAC”). Additional examples of suitable quaternary ammonium compounds can include alkyl dimethyl ethyl benzyl ammonium chloride (“ADEBAC”), alkyl dimethyl 1-naphtylmethyl ammonium chloride, dodecyl benzyl trimethyl ammonium chloride, alkyl trimethyl ammonium chloride, diisobutylphenoxyethyoxyethyl dimethyl benzyl ammonium chloride, and (trihydroxylsilyl) propyldimethyloctadecyl ammonium chloride.

The alkyl chain on the quaternary ammonium compound can be of any suitable length. For example, in certain embodiments, the alkyl chain can be a C₈₋₂₀ alkyl or a C₁₀₋₁₈ alkyl. The quaternary ammonium compound can be any particular quaternary ammonium compound or can be a mixture of different quaternary ammonium compound (e.g., a mixture of quaternary ammonium compounds having different alkyl chains). The quaternary ammonium compound can serve one or more functions in the compositions disclosed herein. For example, the quaternary ammonium compound can be a surfactant or a cleaning agent to treat dirt and/or stains. Examples of such quaternary ammonium compounds can include cationic quaternary ammonium salts. Alternatively, or additionally, quaternary ammonium compounds can be a biocidal agent which has, for example, antimicrobial effects.

The amount of a quaternary ammonium compound in a composition can be selected according to various factors, such as biocidal effectiveness, cleaning effectiveness, one or more physical characteristics (e.g., size, solubility, odor, etc.), toxicity, adverse interactions with other component(s) of the composition (e.g., interactions between the linear saturated monocarboxylic fatty acid, the linear unsaturated monocarboxylic fatty acid, etc.), etc. In certain embodiments, the amount of the quaternary ammonium compound used in a composition described herein can be sufficient to inhibit the growth of surface-growing organisms. In certain embodiments, the amount of the quaternary ammonium compound can be sufficient to treat stains resulting from the growth of surface-growing organisms. In certain embodiments, the amount of the quaternary ammonium compound can be in the range of about 0.1% to about 20% weight to weight (“w/w”) with the other components of the compositions. For example, the amount, w/w, of the quaternary ammonium compound in the composition can be about 0.1%, about 0.2%, about 0.3%, about 0.4%, about 0.5%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, or about 3.5%, about 4.0%, about 4.5%, about 5.0%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, about 13%, about 13.5%, about 14%, about 14.5%, about 15%, about 15.5%, about 16%, about 16.5%, about 17%, about 17.5%, about 18%, about 18.5%, about 19%, about 19.5%, or about 20% in various embodiments.

Alternatively, the amount, w/w, of the quaternary ammonium compound in the composition can also be a range of from about 0.5% to 3.0%, about 0.5% to about 2.5%, about 0.5% to about 2.0%, about 0.5% to about 1.5%, about 0.5% to about 1.0%, about 1.0% to about 3.5%, about 1.0% to about 3.0%, about 1.0% to about 2.5%, about 1.0% to about 2.0%, about 1.0% to about 1.5%, about 1.5% to about 3.5%, about 1.5% to about 3.0%, about 1.5% to about 2.5%, about 1.5% to about 2.0%, about 2.0% to about 3.5%, about 2.0% to about 3.0%, about 2.0% to about 2.5%, about 2.5% to about 3.5%, about 2.5% to about 3.0%, or about 3.0% to about 3.5% in various embodiments. As can be appreciated, other amounts of the quaternary ammonium compound sufficient to inhibit the growth of surface-growing organisms or to remove stains resulting from the growth of surface-growing organisms can also be suitable, including amounts below 0.5%, amounts above 3.5%, and ranges different than about 0.5% to about 3.5%.

In certain embodiments, the compositions described herein can be concentrated liquids. In such embodiments, the quaternary ammonium compound can be in the range of about 5% to about 20% w/w. For example, the amount, w/w, of the quaternary ammonium compound in a concentrated liquid composition can be about 5%, about 6%, about 7%, about 8%, about 9%, about 10%, about 11%, about 12%, about 13%, about 14%, about 15%, about 16%, about 17%, about 18%, about 19%, or about 20%. The amount, w/w, of the quaternary ammonium compound in the concentrated liquid composition can also be a range of from about 5% to about 15%, about 5% to about 10%, about 10% to about 20%, about 10% to about 15%, or about 15% to about 20%. As can be appreciated, other amounts of the quaternary ammonium compound in the concentrated liquid composition can also be suitable, including amounts below 5%, amounts above 20%, and in ranges different than about 5% to about 20%.

In certain embodiments, the compositions described herein can further include a linear monocarboxylic fatty acid. In certain embodiments, a linear monocarboxylic fatty acid can be a linear saturated fatty acid. In certain embodiments, the linear monocarboxylic fatty acid can be a linear unsaturated fatty acid. Suitable linear monocarboxylic fatty acids can be any particular fatty acid or a mixture of different fatty acids. For example, the compositions described herein can include only a linear saturated monocarboxylic acid, only a linear unsaturated monocarboxylic acid, or a combination of such linear monocarboxylic acids in various embodiments.

Examples of suitable saturated linear monocarboxylic fatty acids can include caprylic acid, pelargonic acid, capric acid, undecylic acid, lauric acid, and tridecylic acid; corresponding to molecular formulas CH₃(CH₂)₆COOH, CH₃(CH₂)₇COOH, CH₃(CH₂)₈COOH, CH₃(CH₂)₉COOH, CH₃(CH₂)₁₀COOH, and CH₃(CH₂)₁₁COOH. Examples of suitable linear unsaturated fatty acid that can include undecylenic acid, myristoleic acid, palmitoleic acid, oleic acid, and linoleic acid. Linear monocarboxylic fatty acids can serve one or more functions in the compositions described herein. For example, the linear monocarboxylic fatty acids can serve as a pesticide (encompassing activity as an herbicide, fungicide, algaecide, or other biocidal activity against surface-growing organisms) in certain embodiments.

The amount of a linear monocarboxylic fatty acids in a composition described herein can be selected according to various factors, such as biocidal effectiveness, cleaning effectiveness, physical characteristics (e.g. size, solubility, and/or odor), toxicity, adverse interactions with another component(s) of the mixture (e.g., with the quaternary ammonium compound), etc. In certain embodiments, the amount of the linear monocarboxylic fatty acids in the composition can be sufficient to inhibit the growth of surface-growing organisms. In certain embodiments, the amount of the linear monocarboxylic fatty acids can be sufficient to treat stains resulting from the growth of surface-growing organisms. In certain embodiments, the amount of the linear monocarboxylic fatty acids can be in the range of about 0.1% to about 25.0% w/w. For example, the amount, w/w, of the linear monocarboxylic fatty acid can be about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.25%, about 5.5%, about 5.75%, about 6.0%, about 6.25%, about 6.5%, about 6.75%, about 7.0%, about 7.25%, about 7.5%, about 7.75%, about 8.0%, about 8.25%, about 8.5%, about 8.75%, about 9.0%, about 9.25%, about 9.5%, about 9.75%, about 10.0%, about 10.5%, about 11.0%, about 11.5%, about 12.0%, about 12.5%, about 13.0%, about 13.5%, about 14.0%, about 14.5%, about 15.0%, about 15.5%, about 16.0%, about 16.5%, about 17.0%, about 17.5%, about 18.0%, about 18.5%, about 19.0%, about 19.5%, about 20.0%, about 20.5%, about 21.0%, about 21.5%, about 22.0%, about 22.5%, about 23.0%, about 23.5%, about 24.0%, about 24.5%, or about 25.0% in various embodiments.

In addition, the amount, w/w, of the linear monocarboxylic fatty acids can be in the range of from about 0.1% to about 3.5%. In certain embodiments, the amount of the linear monocarboxylic fatty acids can be in the range of about 0.1% to about 1% w/w. The amount, w/w, of the linear monocarboxylic fatty acids in the composition can also be a range of from about 0.1% to about 1.0%, about 0.1% to about 0.9%, about 0.1% to about 0.8%, about 0.1% to about 0.7%, about 0.1% to about 0.6%, about 0.1% to about 0.5%, about 0.1% to about 0.4%, about 0.1% to about 0.3%, about 0.1% to about 0.2%, about 0.2% to about 1.0%, about 0.2% to about 0.9%, about 0.2% to about 0.8%, about 0.2% to about 0.7%, about 0.2% to about 0.6%, about 0.2% to about 0.5%, about 0.2% to about 0.4%, about 0.2% to about 0.3%, about 0.3% to about 1.0%, about 0.3% to about 0.9%, about 0.3% to about 0.8%, about 0.3% to about 0.7%, about 0.3% to about 0.6%, about 0.3% to about 0.5%, about 0.3% to about 0.4%, about 0.4% to about 1.0%, about 0.4% to about 0.9%, about 0.4% to about 0.8%, about 0.4% to about 0.7%, about 0.4% to about 0.6%, about 0.4% to about 0.5%, about 0.5% to about 1.0%, about 0.5% to about 0.9%, about 0.5% to about 0.8%, about 0.5% to about 0.7%, about 0.5% to about 0.6%, about 0.6% to about 1.0%, about 0.6% to about 0.9%, about 0.6% to about 0.8%, about 0.6% to about 0.7%, about 0.7% to about 1.0%, about 0.7% to about 0.9%, about 0.7% to about 0.8%, about 0.7% to about 1.0%, about 0.7% to about 0.9%, about 0.7% to about 0.8%, about 0.8% to about 1.0%, about 0.8% to about 0.9%, or about 0.9% to about 1.0%. Other amounts of linear monocarboxylic fatty acids to inhibit the growth of surface-growing organisms or treat stains resulting from the growth of surface-growing organisms can also be included in amounts below 0.1%, amounts above 3%, and in ranges different than about 0.1% to about 3%.

For embodiments wherein the composition is a concentrated liquid, the amount of the linear monocarboxylic fatty acids can be in the range of about 1% to about 25% w/w. For example, the amount, w/w, of the linear monocarboxylic fatty acids in a composition can be about 1.0%, about 1.5%, about 2.0%, about 2.5%, about 3.0%, about 3.5%, about 4.0%, about 4.5%, about 5.0%, about 5.5%, about 6.0%, about 6.5%, about 7.0%, about 7.5%, about 8.0%, about 8.5%, about 9.0%, about 9.5%, about 10.0%, about 10.5%, about 11.0%, about 11.5%, about 12.0%, about 12.5%, about 13.0%, about 13.5%, about 14.0%, about 14.5%, about 15.0%, about 15.5%, about 16.0%, about 16.5%, about 17.0%, about 17.5%, about 18.0%, about 18.5%, about 19.0%, about 19.5%, about 20.0%, about 20.5%, about 21.0%, about 21.5%, about 22.0%, about 22.5%, about 23.0%, about 23.5%, about 24.0%, about 24.5%, or about 25.0% in various embodiments. The amount, w/w, of the linear monocarboxylic fatty acids in a composition described herein can also be a range of from about 1% to about 5%, about 1% to about 4%, about 1% to about 3% about 1% to about 2%, about 2% to about 5%, about 2% to about 4%, about 2% to about 3%, about 3% to about 5%, about 3% to about 4%, or about 4% to about 5%. As can be appreciated, other amounts of the linear monocarboxylic fatty acids can also be included in embodiments where the composition is a concentrated liquid including amounts below 1%, amounts above 5%, and ranges different than about 1% to about 5%.

In certain embodiments, the linear monocarboxylic fatty acids can be provided in the form of a salt with a cation. Any suitable cation can be used in such embodiments, including those commonly used in saponifying fatty acids, such as sodium (Na⁺), potassium (K⁺), and/or calcium (Ca²⁺). In certain embodiments, the cation can be potassium. The use of a potassium cation can be beneficial because potassium is compatible with, and can provide nutrients to, turf grass. As can be appreciated, this can facilitate the use of the compositions described herein outdoors.

In certain embodiments, the composition can include a plant essential oil. For example, the compositions can include thyme oil, thymol, geranium oil, geraniol, eugenol, peppermint oil, cinnamon oil, clove oil, lemongrass oil, mint oil, citronella oil, rosemary oil, citrus oil, garlic oil, pepper oil, d-limonene, linalool, or mixtures thereof in certain embodiments. As can be appreciated, other plant essential oils can alternatively, or additionally be included. Additional examples of other plant essential oils that can be included and how they can be used are described in U.S. patent application Ser. No. 13/844,495 (filed on Mar. 15, 2013) and entitled “Weed Control Composition and Uses Thereof,” the disclosure of which is incorporated by reference herein.

The composition can also include a stabilizing agent in certain embodiments. The inclusion of a stabilizing agent can be useful, for example, to help avoid, or minimize, precipitation of one or more of the components of the composition, such as a linear monocarboxylic fatty acid or a quaternary ammonium compound. Alternatively, or additionally, a stabilizing agent can also be included to prevent degradation of one or more of the components, such as a linear monocarboxylic fatty acid. Further, a stabilizing agent can be included to avoid any adverse interactions between the components, such as interactions of certain components with a quaternary ammonium compound.

In certain embodiments, a stabilizing agent can be a surfactant that can serve as an emulsifier or dispersant. Such stabilizing agents can be useful, for example, if the quaternary ammonium compound complexes with the salts of the linear monocarboxylic fatty acids. As can be appreciated, use of an appropriate surfactant can have various benefits, such as helping to make the composition more homogenous and/or to have a clearer appearance. In certain embodiments, the surfactant can be a hydrophilic non-ionic surfactant or an amphoteric surfactant. Among such surfactants, those having a relatively higher hydrophilic-lipophilic balance (HLB) can be particularly suitable in certain embodiments. In certain embodiments, a hydrophilic surfactant (non-ionic or amphoteric) can have a HLB of 10 or more; and in certain embodiments, 15 or more. Examples of suitable hydrophilic surfactants (non-ionic or amphoteric) can include ethoxylated alcohols and alkylphenols, fatty acid esters, polysorbates (such as Tween 40 or Tween 20), nitrogenated nonionic surfactant, alkylpolyglucosides, etc.

As can be appreciated, other stabilizing agents can alternatively, or additionally, be included. For example, chelating agents, antifoam agents, pH buffering agents, viscosity modifiers, and UV inhibitors can each be used as stabilizing agents.

In certain embodiments, the pH of the compositions described herein can be selected such that most of the linear monocarboxylic fatty acids are in an ionized salt form, (i.e. as a carboxylate). In certain embodiments, the pH of the composition can be about 6.5 or above. In certain embodiments, the pH can be in the range of about 6.5 to about 9.5. For example, the pH of the composition can be about 6.5, about 7, about 7.5, about 8, about 8.5, about 9, or about 9.5. In addition, the pH of the composition could be a range of from about 6.5 to about 9.0, 8.5, about 6.5 to about 8.0, about 6.5 to about 7.5, about 6.5 to about 7.0, about 7.0 to about 9.5, about 7.0 to about 9.0, about 7.0 to about 8.5, about 7.0 to about 8.0, about 7.0 to about 7.5, about 7.5 to about 9.5, about 7.5 to about 9.0, about 7.5 to about 8.5, about 7.5 to about, 8.0, about 8.0 to about 9.5, about 8.0 to about 9.0, about 8.0 to about 9.5, about 8.5 to about 9.5, about 8.5 to about 9.0 in various embodiments. Other pH values sufficient to cause the linear saturated or unsaturated monocarboxylic fatty acid to be in an ionized form can also be used, including pH values below 6.5 or above 9.5, and ranges different than about 6.0 to about 9.5.

In certain embodiments, the pH of the composition can be selected to be higher than the pKa of the linear monocarboxylic fatty acids included in the composition. For example, in embodiments where the compositions include pelargonic acid having a pKa of about 5, the pH of the composition can be about 5 or higher.

In certain embodiments, the composition can be homogenous and can have a clear appearance. Such appearances can be achieved by appropriate selection of the pH, the type and amount of the linear monocarboxylic fatty acids, the type and amount of a quaternary ammonium compound, the presence of surfactant additives, and other factors.

In liquid embodiments of the composition, one or more suitable solvents can be used to dissolve or otherwise disperse the components of the composition. In certain embodiments, the solvent can be aqueous (e.g., water-based). Alternatively, non-aqueous solvents can also be used. For example, glycol ethers (e.g., P-Series by Dow Chemicals), alcohols (e.g., ethanol, isopropanol, etc.), diol/glycols (e.g., propylene glycol, 1,2-butanediol, etc.), limonene, glycerine, or a combination of these or other solvents can be used in certain embodiments. Such solvents can be water soluble, partially water soluble, or water miscible. Liquid compositions can be provided as a concentrated liquid or as a diluted liquid.

In concentrated liquid embodiments, a user can dilute the composition with a solvent (e.g., water). In certain embodiments, the amount of dilution can be about one part of the concentrated liquid composition to about 1 part to about 10 parts of the solvent. In certain embodiments, the amount of dilution can be about one part of the concentrated liquid composition to about 4 to about 8 parts of the solvent. In certain embodiments, the amount of dilution can be about one part of the concentrated liquid composition to about 1 part, about 2 parts, about 3 parts, about 4 parts, about 5 parts, about 6 parts, about 7 parts, about 8 parts, about 9 parts, or about 10 parts of the solvent. For example, a user can dilute one gallon of the concentrated liquid with five gallons of water (1:5 ratio) to yield six gallons of the composition that is ready to use. As can be appreciated, this is an example only, and other amounts of both the concentrated liquid and the solvent can be used. Additionally, other solvents besides water can be used in lieu of, or in addition to, the water.

In certain embodiments, the concentrated liquid can be diluted by mixing the concentrated liquid with a flowing solvent supply (e.g., attaching a concentrated spray bottle to a garden hose and turning on the water). In such embodiments, the amount of the quaternary ammonium compound in the resulting diluted liquid can be in the range of about 0.1% to about 5.0% w/w. For example, the amount, w/w, of the quaternary ammonium compound in the diluted liquid can be about 0.1%, about 0.15%, about 0.2%, about 0.3%, about 0.4%, about 0.5%, about 0.6%, about 0.7%, about 0.75%, about 0.8%, about 0.9%, about 1%, about 1.5%, about 2.0%, about 2.5%, about 3.0%, about 3.5%, about 4.0%, about 4.5%, or about 5.0%.

In certain embodiments, the concentrated liquid can be mixed with a flowing solvent supply and the amount of the linear saturated monocarboxylic fatty acid, the linear unsaturated monocarboxylic fatty acid, or combinations thereof, in the resulting diluted liquid can be in the range of about 0.1% to about 5% w/w. For example, the amount, w/w, of the linear saturated or unsaturated monocarboxylic fatty acid in the concentrated liquid can be about 0.1%, about 0.2%, about 0.3%, about 0.4%, about, about 0.5%, about 0.6%, about 0.7%, about 0.8%, about 0.9%, about 1.0%, about 1.5%, about 2.0%, about 2.5%, about 3.0%, about 3.5%, about 4.0%, about 4.5%, or about 5.0%.

In certain embodiments, the composition can be a pesticide agent that can inhibit the growth of surface-growing organisms. In certain embodiments, the compositions can advantageously act as relatively fast-acting biocidal agents against surface-growing organisms. In certain embodiments, the compositions can inhibit the growth of surface-growing organisms within about 120 hours after application. For example, the compositions described herein can inhibit the growth of surface-growing organisms within about 3 hours after application, within about 6 hours after application, within about 12 hours after application, within about 18 hours after application, within about 24 hours after application, within about 30 hours after application, within about 36 hours after application, within about 42 hours after application, within about 48 hours after application, within about 54 hours after application, within about 60 hours after application, within about 66 hours after application, within about 72 hours after application, within about 78 hours after application, within about 84 hours after application, within about 90 hours after application, within about 96 hours after application, within about 102 hours after application, within about 108 hours after application, within about 114 hours after application, within about 120 hours after application, etc.

In certain embodiments, the compositions can be cleaning agents that can treat stains caused by surface-growing organisms. In certain embodiments, the compositions described herein can advantageously act as a relatively fast cleaning agent. In certain embodiments, the composition can visibly remove, or reduce, stains caused by surface-growing organisms within 72 hours after application. For example, certain compositions can visibly remove, or reduce, stains caused by surface-growing organisms within about 6 hours after application, within about 12 hours after application, within about 18 hours after application, within about 24 hours after application, within about 30 hours after application, within about 36 hours after application, within about 42 hours after application, within about 48 hours after application, within about 54 hours after application, within about 60 hours after application, within about 66 hours after application, within about 72 hours after application, etc.

In certain embodiments, the compositions described herein can also advantageously exhibit a relatively long residual activity. Such residual activity can be particularly advantageous for outdoor use because it improves rainfastness. As can be appreciated, rainfastness can reduce the frequency in which the composition needs to be reapplied. In certain embodiments, the composition can be applied at a frequency in the range of once every three months to once every nine months. For example, the composition can be applied once every three months, once every four months, once every six months, once every seven months, once every eight months, or once every nine months. In certain embodiments, the compositions can be applied more frequently than once every three months (e.g., once every 1 to 2 months) or can be applied less frequently than once every nine months (e.g., once every 10-15 months).

As can be appreciated, the amount of the composition that can be applied will depend on various factors such as the components of the composition, the concentration of the components in the composition, the viscosity of the composition, etc. For certain embodiments where the composition is a concentrated liquid, the composition can be applied in an amount equivalent to about 500 to about 2500 square feet per one gallon. For certain embodiments in which the composition is provided as a ready-to-use product (e.g., in a ready-to-spray bottle or garden hose attachment), the composition can be applied in amount equivalent to about 600 square foot or less per 32 ounces.

The following examples are included merely to illustrate certain aspects and embodiments of the disclosure, and are not intended to be limiting.

### Examples

An experiment was conducted on an outdoor concrete surface on which algae was naturally growing. In the experiment, several formulations were prepared as Examples and applied to the concrete surface to evaluate their algae removal effects. The Examples included a Control which was prepared using 1.66% w/w of ADBAC in water and two inventive Examples. Example 1 contained 1.66% ADBAC (w/w), 0.25% pelargonic acid (w/w), and 1% Tween 20 (w/w) in water. Example 2 contained 1.66% ADBAC (w/w), 0.5% pelargonic acid (w/w), and 2% Tween 20 (w/w) in water. The pH of Examples 1 and 2 were both adjusted to have a pH of 7.5 to 8 with potassium hydroxide. 1 mL of each Example and the Control were applied onto the algae covered concrete surface.

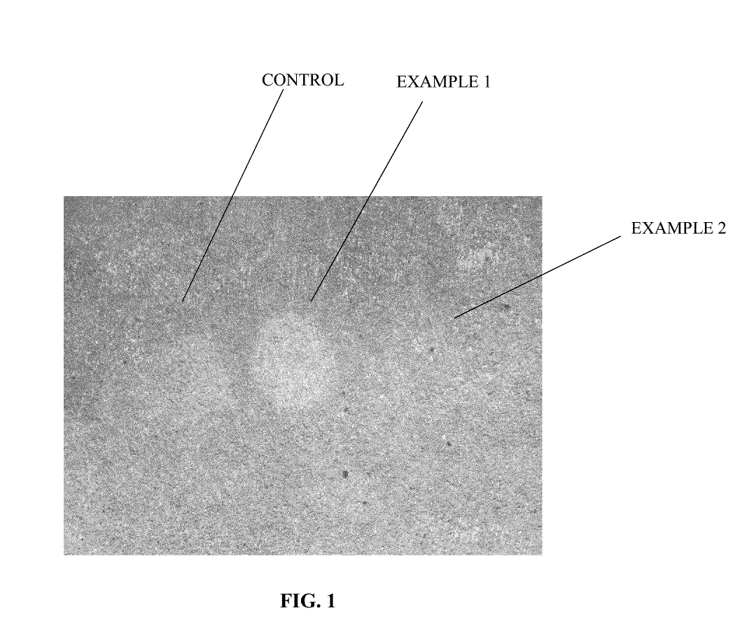

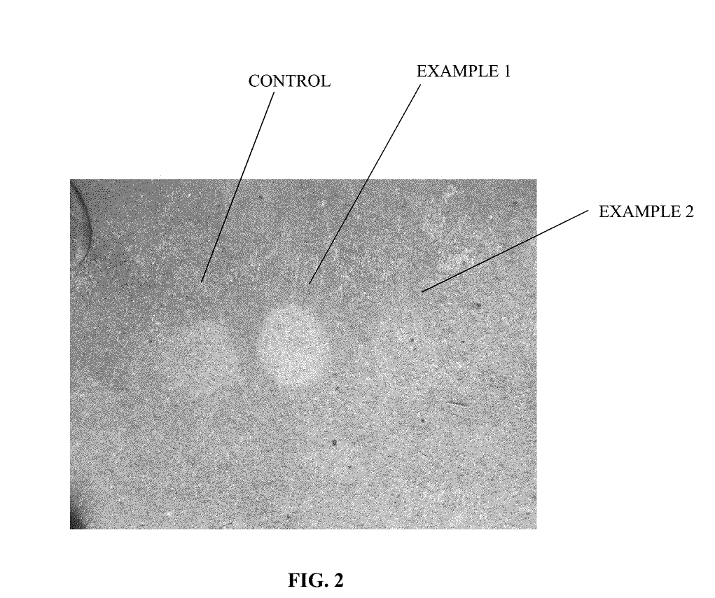

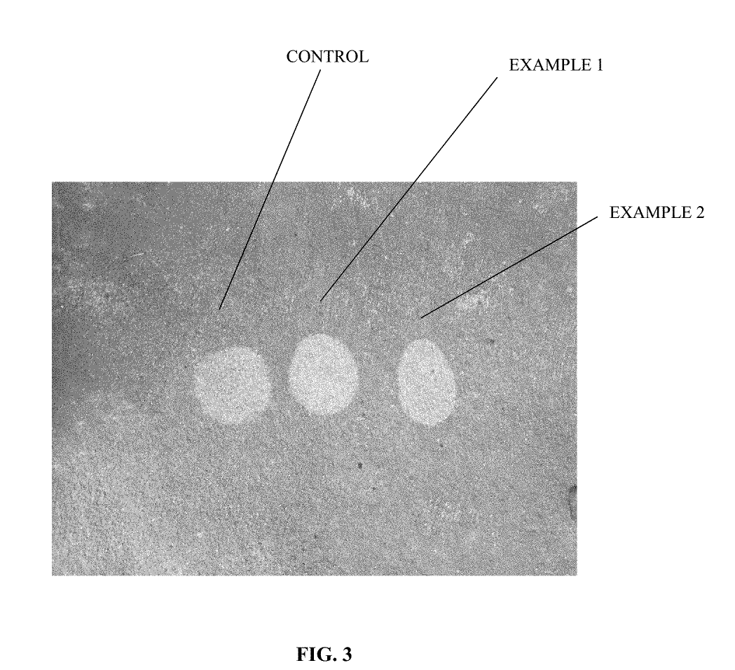

FIGS. 1 to 3 are photographs illustrating the results of the experiment. In each photograph, the Control is the patch on the left, Example 1 is the patch in the middle, and Example 2 is the patch on the right. FIG. 1 depicts the cleaning effect of the Examples 6.5 hours after application; FIG. 2 depicts the cleaning effect of the Examples 24 hours after application; and FIG. 3 depicts the cleaning effect of the Examples 4 days after application.

As illustrated by FIG. 1, Examples 1 and 2 demonstrated better algae removal than the Control with Example 1 demonstrating substantial algae removal and Example 2 demonstrating moderate to minimal algae removal. The Control, in contrast, demonstrated minimal algae removal.

FIG. 2 demonstrated similar results. In FIG. 2, Example 1 demonstrated near complete removal of algae while Example 2 and the Control demonstrated moderate and minimal algae removal respectively.

FIG. 3 illustrates that after 4 days, each of the Examples demonstrate similar algae removal with each removing substantially all of the algae.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of ordinary skill in the art. Rather it is hereby intended the scope be defined by the claims appended various embodiments. The scope is, of course, not limited to the examples or embodiments set forth herein, but can be employed in any number of applications and equivalent articles by those of hereto.

What is claimed is:

1. A composition comprising:
a quaternary ammonium compound that comprises an alkyl chain; and
a linear monocarboxylic fatty acid.

2. The composition of claim 1, wherein the quaternary ammonium compound comprises one or more of alkyl dimethyl benzyl ammonium chloride (“ADBAC”), alkyl dimethyl ethyl benzyl ammonium chloride (ADEBAC), alkyl dimethyl 1-naphtylmethyl ammonium chloride, dodecyl benzyl trimethyl ammonium chloride, alkyl trimethyl ammonium chloride, diisobutylphenoxyethyoxyethyl dimethyl benzyl ammonium chloride, and (trihydroxylsilyl) propyldimethyloctadecyl ammonium chloride.

3. The composition of claim 2, wherein the quaternary ammonium compound is ADBAC.

4. The composition of claim 1, wherein the quaternary ammonium compound comprises a C₈₋₂₀ alkyl chain.

5. The composition of claim 1, wherein the linear monocarboxylic acid comprises one or more of a linear saturated monocarboxylic acid and a linear unsaturated monocarboxylic acid.

6. The composition of claim 1, wherein the linear monocarboxylic fatty acid comprises one or more of caprylic acid, pelargonic acid, capric acid, lauric acid, tridecylic acid, undecylenic acid, myristoleic acid, palmitoleic acid, oleic acid, and linoleic acid.

7. The composition of claim 1 further comprising a plant essential oil, the plant essential comprising one or more of thyme oil, thymol, geranium oil, geraniol, eugenol, peppermint oil, cinnamon oil, clove oil, lemongrass oil, mint oil, citronella oil, rosemary oil, citrus oil, garlic oil, pepper oil, d-limonene, and linalool.

8. The composition of claim 1 comprises an amount of the quaternary ammonium compound and the linear monocarboxylic acid sufficient to inhibit the growth of surface-growing organisms or remove stains resulting from the growth of the surface-growing organisms.

9. The composition of claim 1 comprises about 0.1% to about 20% w/w of the quaternary ammonium compound.

10. The composition of claim 1 comprises about 0.1% to about 25% w/w of the linear monocarboxylic acid.

11. The composition of claim 1 is contained in a spray bottle.

12. The composition of claim 1 further comprising a hydrophilic non-ionic surfactant.

13. The composition of claim 1 has a pH of about 6.5 to about 9.5.

14. The composition of claim 1 is clear and homogenous.

15. A method of inhibiting the growth of an organism or treating a stain resulting from the growth of an organism, comprising applying to the organism the composition of claim 1.

16. The method of claim 15, wherein the organism is on a hard surface of a man-made structure and the composition is applied onto the hard surface.

17. The method of claim 15, wherein the composition is applied by mixing the composition with a flowing solvent supply.

18. The method of claim 15, wherein the organism is one or more of algae, lichen, mold, mildew, and moss.

19. A method of preparing a diluted liquid composition, comprising adding a solvent to the composition of claim 1.

20. The method of claim 19, wherein about 1 part to about 10 parts of the solvent are mixed with about 1 part of the composition.
